(19) United States
(12) Patent Application Publication
(10) Pub. No.: US 2022/0397334 A1
(43) Pub. Date: Dec. 15, 2022

(54) Foam separator for polyurethane foams

(71) Applicant: BASF SE, Ludwigshafen (DE)

(72) Inventor: Mathias WEICKERT, Ludwigshafen (DE)

(73) Assignee: BASF SE, Ludwigshafen (DE)

(21) Appl. No.: 17/753,933

(22) PCT Filed: Sep. 25, 2020
(86) PCT No.: PCT/EP2020/076964

§ 371 Date: Mar. 18, 2022

(30) Foreign Application Priority Data
Sep. 27, 2019 (EP) 19200113.9

(51) Int. Cl. F25D 23/02; B29C 44/34; B29C 44/04; B29C 44/42; B29C 44/18

(52) U.S. Cl. CPC F25D 23/028; B29C 44/355; B29C 44/0469; B29C 44/42; B29C 44/18; B29K 2075/00

(57) ABSTRACT

A process can be used for preparing thermally insulating articles containing a thermally insulating polyurethane foam producible in place, a casing surrounding the thermally insulating polyurethane foam, and a foam separator located within the thermally insulating polyurethane foam. The thermally insulating articles producible according to this process are useful. Corresponding cooling systems like fridges, heat storage systems, insulation panels for construction, insulated pipes, mobile transport systems, water boilers, burners, chimneys, instrument panels, roofs of industry hails, engines, or caravans contain the thermally insulating article.

The invention relates to a process for preparing thermally insulating articles comprising a thermally insulating polyurethane foam producible in place, a casing surrounding the thermally insulating polyurethane foam, and a foam separator located within the thermally insulating polyurethane foam, to the thermally insulating articles producible according to this process and to cooling systems like fridges, heat storage systems, insulation panels for construction, insulated pipes, mobile transport systems, water boilers, burners, chimneys, instrument panels, roofs of industry halls, engines, or caravans comprising the thermally insulating article.

Thermally insulating polyurethane (PU) foams can be produced in a known manner by reacting organic polyisocyanates with one or more compounds containing at least two reactive hydrogen atoms, like amines or polyethers, polyesters and/or polyether ester alcohols (polyols), usually in the presence of blowing agents, catalysts and optionally auxiliaries and/or additives.

Thermally insulating PU foams are often rigid, closed-cell foams wherein the cells are filled with gaseous compounds generated during the foaming process like CO₂ or added as blowing agents like C₅ hydrocarbons, which have lower thermal conductivity than air. Such PU foams are used for example in refrigerators, pipes, construction panels, caravan walls etc. It is also possible to prepare open-cell PU foams which are placed into a vacuum tight cover and which are evacuated afterwards. An example of this kind of thermally insulating article are vacuum insulation panels.

Articles comprising thermally insulating PU foams may be produced directly in place by injecting a PU foam reaction mixture into a casing wherein the PU foam forms in situ within the casing. Such casing could e.g. be formed by the inner and outer cover of a refrigerator, the inner and outer wall of a caravan wall, an inner and an outer tube of a pipe etc. For the mechanical and the thermal insulation properties of the foamed article it is import that a uniform filling of the casing and a uniform reaction is achieved during the injection of the PU foam reaction mixture. Parameters influencing the filling and the foaming process are inter alia reaction time of the PU foam reaction mixture, injection time and pressure, flow properties of PU foam reaction mixture, and size and geometry of the cavity to be filled. The geometry of the cavities to be filled can be complex, e.g. in case of a complex outer form like a caravan wall with a window or in case inserts are present like vacuum panels or parts of the condenser or heat exchanger in a refrigerator. Such complex geometries act as obstacles for the flow of the foam reaction mixture. In case of large cavities, it might be necessary to inject more than one stream of the foam reaction mixture to obtain a homogeneous filling within the reaction time of the foam reaction mixture. A further issue to be considered during the preparation of the foam is that the air present in the cavity has to be replaced by the foam and has to find a way out of the cavity.

So it might happen during the filling of a cavity with a PU foam reaction mixture, that two streams of the foam reaction mixture converge within the cavity and form a weld line. In the area of convergence, the two streams may interact with each other and may disturb the flow of each other. Furthermore, the foaming reaction already starts before the cavity is filled completely. With progressing foaming reaction, the chemical composition of the foam reaction mixture and their physical properties change. In consequence, the mixing of two separate streams becomes more and more difficult and, in the end, when the foam reaction mixture has almost reached its final foam structure, it might even become impossible. Unfortunately, weld lines are a source of inhomogeneities and show worse thermal insulation and mechanical strength than regions outside the weld lines.

It is an object of the present invention to provide an improved process for the preparation of thermally insulating articles which are prepared by in place foaming of a foam reaction mixture. In particular, problems arising by converging streams of the foam forming reaction mixture during the preparation should be mitigated. A further object of the present invention is to provide thermally insulated articles producible by in place foaming with improved thermal insulation and/or mechanical properties.

This object is achieved by a process for preparing a thermally insulating article comprising

(i) a thermally insulating polyurethane foam, and

(ii) a casing surrounding the thermally insulating polyurethane foam, said casing comprising
(iia) at least one inlet for the injection of a polyurethane foam reaction mixture,
(iib) at least one air outlet for the air displaced during the foaming reaction of the polyurethane foam reaction mixture, and
(iic) at least one foam separator,

by injecting the polyurethane foam reaction mixture into the at least one inlet of the casing and foaming the polyurethane foam reaction mixture, wherein during the injection and/or foaming reaction at least two separate streams of the polyurethane foam reaction mixture converge within the casing and wherein the foam separator is provided along the area of convergence of the at least two streams.

The object is additionally achieved by a thermally insulating article producible according to the above-mentioned process and by a thermally insulating article comprising

(i) an in-place-foamed thermally insulating polyurethane foam, and

(ii) a casing surrounding the in-place-foamed thermally insulating foam, said casing comprising
(iia) at least one inlet for the injection of a polyurethane foam reaction mixture for the in-place-foaming of the thermally insulating foam,
(iib) at least one air outlet for the air displaced during the in-place-foaming of the thermally insulating foam, and
(iic) at least one foam separator,

wherein the foam separator is located within the in-place-foamed thermally insulating polyurethane foam along the area of convergence of at least two streams of the polyurethane foam reaction mixture during the in-place-foaming of the thermally insulating foam.

The object is likewise achieved by a cooling system like a fridge, a heat storage system, an insulation panel for construction, an insulated pipe, a mobile transport system, a water boiler, a burner, a chimney, an instrument panel, roof of an industry hall, an engine, or a caravan comprising a thermally insulating article described above and hereinafter.

The provision of foam separators at the area of convergence of two or more streams of the foam reaction mixture mitigates the disadvantages like inhomogeneous thermal conductivity and lower mechanical strength arising from the convergence. The introduction of the foam separators provides a safe air vent, since the air is lead along the foam separator. Additionally, the foam separator also leads to a more homogenous filling of the cavity in case of asymmetric placement of the inlet for the injection which is sometimes necessary for technical reasons. The foam separators may further be selected to add further mechanical strength to the whole article or an additional gas diffusion barrier, since they may be selected from materials having higher mechanical strength or gas diffusion barrier properties than the insulating foam.

The invention is described in more detail below.

One aspect of the invention is a process for preparing a thermally insulating article comprising

(i) a thermally insulating polyurethane foam, and

(ii) a casing surrounding the thermally insulating polyurethane foam, said casing comprising
(iia) at least one inlet for the injection of a polyurethane foam reaction mixture,
(iib) at least one air outlet for the air displaced during the foaming reaction of the polyurethane foam reaction mixture, and
(iic) at least one foam separator,

by injecting the polyurethane foam reaction mixture into the at least one inlet of the casing and foaming the polyurethane foam reaction mixture, wherein during the injection and/or the foaming reaction at least two separate streams of the polyurethane foam reaction mixture converge within the casing and wherein the foam separator is provided along the area of convergence of the at least two streams.

The term “area of convergence” means herein the area where the at least two streams of the foam reaction mixture would actually meet and converge in case there would be no foam separator.

Thermally insulating polyurethane foams and their preparation are known to the person skilled in the art, see for example Polyurethane Handbook, 2^{nd} edition 1993, editor Guenter Oertel, Carl Hanser Verlag Munich. The term “polyurethane” is known by the person skilled in the art as including not only polymers containing urethane groups but as also including polymers containing no or very low amounts of urethane groups, as long as these polymers are derived from difuntional or polyfunctional isocyanates, see Polyurethane Handbook, 2^{nd} edition 1993, editor Guenter Oertel, Carl Hanser Verlag Munich, Chapter 2.1.1. Examples are polyetherureas, polyisocyanurates, polyureas and polycarbodiimides.

According to the invention, the thermally insulating polyurethane foam is prepared by foaming in place a polyurethane foam reaction mixture. Such polyurethane foam reaction mixtures, herein-after also referred to as foam reaction mixtures or PU foam reaction mixtures, comprise usually a polyol component P) containing one or more compounds containing at least two reactive hydrogen atoms and an isocyanate component PI) containing one or more organic polyisocyanates having at least two isocyanate groups. Further ingredients of the foam reaction mixture are usually blowing agents, catalysts and optionally auxiliaries and/or additives. The polyol component P) and the isocyanate component PI) are usually reacted in amounts such that the isocyanate index is 80 to 400, preferably 90 to 280, more preferred 100 to 200, particularly preferably 105 to 150.

During the foaming reaction, urethane units are formed but depending on the components present and their ratio, also isocyanurate and/or urea units and/or further units derived from isocyanate groups may be formed.

As organic isocyanates, it is possible to use all usual aliphatic, cycloaliphatic and preferably aromatic diisocyanates and/or polyisocyanates. As preferred isocyanates, it is possible to use toluylene diisocyanate (TDI) and/or diphenylmethane diisocyanate (MDI), preferably MDI, and particularly preferably mixtures of MDI and polymeric diphenylmethane diisocyanate (PMDI). These particularly preferred isocyanates can have been modified fully or partially with uretdione, carbamate, isocyanurate, carbodiimide or allophanate groups. Furthermore, prepolymers and mixtures of the above-described isocyanates and prepolymers can be used as isocyanate component. These prepolymers are prepared from the above-described isocyanates and the polyethers, polyesters or both described below and have an NCO content of usually from 14 to 32% by weight, preferably from 22 to 30% by weight.

As relatively high molecular weight compounds having groups which are reactive toward isocyanates, it is possible to use all compounds which have at least two groups which are reactive toward isocyanates, e.g. OH-, SH-, NH- and CH-acid groups. It is usual to use polyetherols and/or polyesterols having from 2 to 8, preferably from 2 to 6, hydrogen atoms which are reactive toward isocyanate. The OH number of these compounds is usually in the range from 30 to 850 mg KOH/g, preferably in the range from 100 to 500 mg KOH/g.

The polyetherols are obtained by known methods, for example by anionic polymerization of alkylene oxides with addition of at least one starter molecule comprising from 2 to 8, preferably from 2 to 6, reactive hydrogen atoms in bound form in the presence of catalysts. As catalysts, it is possible to use alkali metal hydroxides such as sodium hydroxide or potassium hydroxide or alkali metal alkoxides such as sodium methoxide, sodium or potassium ethoxide or potassium isopropoxide, or in the case of cationic polymerization Lewis acids such as antimony pentachloride, boron trifluoride etherate or bleaching earth as catalysts. Furthermore, double metal cyanide compounds, known as DMC catalysts, can also be used as catalysts. Furthermore, polyetherols can be prepared using amines as catalyst as for example disclosed in WO2011/134866 or WO2011/134856 A1. Preference is given to using one or more alkylene oxides having from 2 to 4 carbon atoms in the alkylene radical, e.g. ethylene oxide, 1,2-propylene oxide, 1,3-propylene oxide, 1,2- or 2,3-butylene oxide, or tetrahydrofuran, in each case either alone or in the form of mixtures, particularly preferably ethylene oxide and/or 1,2-propylene oxide, as alkylene oxides. Possible starter molecules are, for example, ethylene glycol, diethylene glycol, glycerol, trimethylolpropane, pentaerythritol, sugar derivatives such as sucrose, hexitol derivatives such as sorbitol, also methylamine, ethylamine, isopropylamine, butylamine, benzylamine, aniline, toluidine, toluenediamine, in particular vicinal toluenediamine, naphthylamine, ethylenediamine, di-ethylenetriamine, 4,4′-methylenedianiline, 1,3,-propanediamine, 1,6-hexanediamine, ethanolamine, diethanolamine, triethanolamine and other dihydric or polyhydric alcohols or monofunctional or polyfunctional amines. Preference is given to ethylene glycol, diethylene glycol, glycerol, trimethylolpropane, pentaerythritol, sugar derivatives such as sucrose and hexitol derivatives such as sorbitol and TDA, preferably vic-TDA.

The polyester alcohols used are usually prepared by condensation of polyfunctional alcohols having from 2 to 12 carbon atoms, e.g. ethylene glycol, diethylene glycol, butanediol, trimethylolpropane, glycerol or pentaerythritol, with polyfunctional carboxylic acids having from 2 to 12 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, the isomers of naphthalenedicarboxylic acids or the anhydrides of the acids mentioned. As further starting materials in the preparation of the polyesters, it is also possible to make concomitant use of hydrophobic materials. The hydrophobic materials are water-insoluble materials which comprise a nonpolar organic radical and have at least one reactive group selected from among hydroxyl, carboxylic acid, carboxylic ester or mixtures thereof. The equivalent weight of the hydrophobic materials is preferably in the range from 130 to 1000 g/mol. It is possible to use, for example, fatty acids such as stearic acid, oleic acid, palmitic acid, lauric acid or linoleic acid and also fats and oils such as castor oil, maize oil, sunflower oil, soybean oil, coconut oil, olive oil or tall oil.

The polyesterols used preferably have a functionality of from 1.5 to 5, particularly preferably from 1.8 to 3.5. If isocyanate prepolymers are used as isocyanates, the content of compounds having groups which are reactive toward isocyanates is calculated with inclusion of the compounds having groups which are reactive toward isocyanates used for preparing the isocyanate prepolymers.

The polyurethane foam of the inventive thermal insulation element is usually prepared by means of at least one physical or chemical blowing agent, e.g. selected from non-halogenated hydrocarbons, partially halogenated hydrocarbons and water.

Examples of partially halogenated hydrocarbons are C₂ to C₆ fluoroalkenes, particularly preferably C₃ to C₆ fluoroalkenes like propenes, butenes, pentenes and hexenes having 3 to 6 fluorine substituents, where other substituents such as chlorine may be present, examples are tetrafluoropropenes, fluorochloropropenes like trifluoromonochloropropenes, pentafluoropropenes, fluorochlorobutenes, hexafluorobutenes or mixtures thereof.

Fluorinated alkenes that are particularly preferred as blowing agents used for the preparation of the closed-cell rigid polyurethane foam are selected from the group consisting of cis- or trans-1,3,3,3-tetrafluoroprop-1-ene, 1,1,1-trifluoro-2-chloroprop-1-ene, 1-chloro-3,3,3-trifluoroprop-1-ene, 1,1,1,2,3-pentafluoroprop-1-ene, in cis or trans form, 1,1,1,4,4,4-hexafluorobut-2-ene, 1-bromopentafluoroprop-1-ene, 2-bromopentafluoroprop-1-ene, 3-bromopentafluoroprop-1-ene, 1,1,2,3,3,4,4-heptafluoro-1-butene, 3,3,4,4,5,5,5-heptafluoro-1-pentene, 1-bromo-2,3,3,3-tetra-fluoroprop-1-ene, 2-bromo-1,3,3,3- tetrafluoroprop-1-ene, 3-bromo-1,1,3,3-tetrafluoroprop-1-ene, 2-bromo-3,3,3-trifluoroprop-1-ene, (E)-1-bromo-3,3,3-trifluoroprop-1-ene, 3,3,3-trifluoro-2-(tri-fluoromethyl)prop-1-ene, 1-chloro-3,3,3-trifluoroprop-1-ene, 2-chloro-3,3,3-trifluoroprop-1-ene, 1,1,1-trifluoro-2-butene and mixtures thereof.

Examples of non-halogenated hydrocarbon blowing agents are acyclic pentane isomers and/or cyclopentane, especially cyclopentane. Preference is given to using acyclic pentane isomers and/or cyclopentane in the range from 3% to 12% by weight, based on the total amount of the polyurethane foam reaction mixture. Preference is given to cyclopentane and mixtures of isopentane with cyclopentane having a content of at least 70% by weight of cyclopentane, and particular preference is given to using cyclopentane having a purity of at least 90% by weight, especially of at least 95% by weight.

Water is a chemical blowing agent which is especially preferably employed at a concentration of 1% to 8% by weight, preferably of 1.2% to 6%, more preferably 1.4% to 5% most preferably 1.5% to 3.5% by weight based on the total amount of polyurethane foam reaction mixture with-out physical blowing agent(s).

As catalysts, it is possible to use all compounds which accelerate the isocyanate-water reaction or the isocyanate-polyol reaction. Such compounds are known and are described, for example, in “Kunststoffhandbuch, Volume 7, Polyurethane”, Carl Hanser Verlag, 3rd Edition 1993, Chapter 3.4.1. These include amine-based catalysts and catalysts based on organic metal compounds. As catalysts based on organic metal compounds, it is possible to use, for example, organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates such as bismuth(III) neodecanoate, bismuth 2-ethylhexanoate and bismuth octanoate or alkali metal salts of carboxylic acids, e.g. potassium acetate or potassium formate. It is also possible to use catalysts promoting the formation of isocyanurate or urea groups.

Preference is given to using a mixture comprising at least one tertiary amine as catalyst. These tertiary amines may also bear groups which are reactive toward isocyanate, e.g. OH, NH or NH₂ groups. Some of the most frequently used catalysts are bis(2-dimethylaminoethyl) ether, N,N,N,N,N-pentamethyldiethylenetriamine, N,N,N-triethylaminoethoxyethanol, dimethylcyclohexylamine, dimethylbenzylamine, triethylamine, triethylenediamine, pentamethyldipropylenetriamine, dimethylethanolamine, N-methylimidazole, N-ethylimidazole, tetramethylhexamethylenediamine, tris(dimethylaminopropyl)hexahydrotriazine, dimethylaminopropylamine, N-ethylmorpholine, diazabicycloundecene and diazabicyclononene. Preference is given to using mixtures comprising at least two different tertiary amines as catalysts.

Foam stabilizers are materials which promote formation of a regular cell structure during foaming. Examples are: silicone-comprising foam stabilizers such as siloxaneoxalkylene copolymers and other organopolysiloxanes. Also alkoxylation products of fatty alcohols, oxo alcohols, fatty amines, alkylphenols, dialkylphenols, alkylcresoles, alkylresorcinol, naphthol, alkylnaphthol, naphthylamine, aniline, alkylaniline, toluidine, bisphenol A, alkylated bisphenol A, polyvinyl alcohol and also alkoxylation products of condensation products of formaldehyde and alkylphenols, formaldehyde and dialkylphenols, formaldehyde and alkylcresoles, formaldehyde and alkylresorcinol, formaldehyde and aniline, formaldehyde and toluidine, formaldehyde and naphthol, formaldehyde and alkylnaphthol and also formaldehyde and bisphenol A or mixtures of two or more of these foam stabilizers. Foam stabilizers are preferably used in an amount of from 0.5 to 5% by weight, particularly preferably from 1 to 3% by weight, based on the total weight of the components.

Optionally flame retardants might be used as additives for the foam. As flame retardants, it is generally possible to use the flame retardants known from the prior art. Suitable flame retardants are, for example, nonincorporable brominated substances, brominated esters, brominated ethers (lxol) or brominated alcohols such as dibromoneopentyl alcohol, tribromoneopentyl alcohol and PHT-4-diol and also chlorinated phosphates such as tris(2-chloroethyl) phosphate, tris(2-chloropropyl) phosphate (TCPP), tris(1,3-dichloropropyl) phosphate, tricresyl phosphate, tris(2,3-dibromopropyl) phosphate, tetrakis(2-chloroethyl) ethylenediphosphate, dimethyl methanephosphonate, diethyl diethanolaminomethyl-phosphonate and also commercial halogen-comprising flame retardant polyols. It is possible to use phosphates or phosphonates such as diethyl ethanephosphonate (DEEP), triethyl phosphate (TEP), dimethyl propylphosphonate (DMPP), diphenyl cresyl phosphate (DPK) and others as further liquid flame retardants. Apart from the abovementioned flame retardants, it is possible to use inorganic or organic flame retardants such as red phosphorus, preparations comprising red phosphorus, aluminum oxide hydrate, antimony trioxide, arsenic oxide, ammonium polyphosphate and calcium sulfate, expandable graphite or cyanuric acid derivatives such as melamine, or mixtures of at least two flame retardants, e.g. ammonium polyphosphates and melamine and optionally maize starch or ammonium polyphosphate, melamine, expandable graphite and optionally aromatic polyesters for making the rigid polyurethane foams flame resistant. Preferable flame retardants are the recited phosphorus-containing flame retardants, particular preference being given to dimethyl propylphosphonate (DMPP), diethyl ethanephosphonate (DEEP), triethyl phosphate (TEP), diphenyl cresyl phosphate (DPK), triphenyl phosphate (TPP) and tris-(2-chloropropyl) phosphate (TCPP), with special preference being given to TCPP.

Further auxiliaries and/or additives can optionally be added to the foam reaction mixture for producing the polyurethane foams like surface-active substances, cell regulators, fillers, dyes, pigments, flame retardants, hydrolysis inhibitors, fungistatic and bacteriostatic substances.

The thermally insulating polyurethane foam is preferably a rigid polyurethane foam. Such rigid polyurethane foams which are in particular suited for thermal insulation applications are described in detail in Polyurethane Handbook, 2^{nd} edition 1993, editor Guenter Oertel, Carl Hanser Verlag Munich, chapter 6.

The insulating polyurethane foam may be an open-cell or a closed-cell foam, preferably it is a closed-cell foam. The term “closed cell” as used herein means that the foam has a content of open cells of up to 20%, preferred up to 10% and most preferred up to 5%, see Polyurethane Handbook, 2^{nd} edition, 1993, editor Guenter Oertel, Carl Hanser Verlag Munich, Chapter 6.3.1.4. The content of open cells may be determined according to DIN EN ISO 4590 valid in 2016. Such foams are known to the person skilled in the art and are especially valued for their thermal insulation properties.

In particular preferred the insulating polyurethane foam is a rigid, closed-cell polyurethane foam.

The density of the thermally insulating polyurethane foam is preferably in the range of 15 to 300 kg/m³, more preferred in the range of 16 to 200 kg/m³, even more preferred in the range of 18 to 150 kg/m³, most preferred in the range of 20 to 100 kg/m³, and in particular preferred 22 to 70 kg/m³.

Usually the foam reaction mixture is prepared by mixing the components directly before injecting the foam reaction mixture into the casing. The starting components are usually mixed at a temperature of 10 to 30° C., preferably of 15 to 30° C. and in particular of 15 to 25° C., and introduced into the casing. Mixing is customarily carried out in a high-pressure mixing head. The temperature of the casing is advantageously 10 to 70° C., preferably 30 to 50° C. After the mixing the polyurethane foam reaction mixture is usually directly injected into the casing.

According to the present invention the term “casing” means the outer shells forming the cavity into which the foaming reaction mixture is injected, and which is filled by the polyurethane foam by the foaming reaction. At the end of the foaming reaction, the casing surrounds the polyurethane foam formed during the reaction. The casing may be composed by one or more parts, e.g. a refrigerator door comprises an outer metal sheet shaped like a trough and an inner liner made of vacuum drawn thermoplastics. In this case the casing according of the invention is composed of the outer metal sheet and the inner liner. In case of an insulated pipe, the pipe comprises an outer tube and an inner tube with a diameter smaller than that of the outer tube. The cavity between the two tubes is filled by the thermally insulating foam. In this case the casing is composed of the inner and the outer tube.

The casing may be completely assembled at the beginning of the injection of the foam reaction mixture and during the injection and the foaming process, i.e. all parts forming the casing are in place during the injection and the foaming process. It is also possible that the casing is not yet assembled completely, i.e. at least one part of the casing is not yet incorporated and the foam reaction mixture is introduced into the casing via the opening left by the at least one missing part. The incompletely assembled casing is closed by inserting the missing part(s) before the foaming reaction is completed. This ensures that the foam formed takes the form of the casing as completely as possible. In this case the inlet for injection is formed by the opening left by the missing part(s). Preferably the casing is completely assembled at the beginning of the injection of the foam reaction mixture and during the injection and the foaming process.

The casing comprises at least one inlet for the injection of the polyurethane foam reaction mixture, at least one air outlet for the air to be displaced during the foaming reaction of the polyurethane foam reaction mixture, and at least one foam separator.

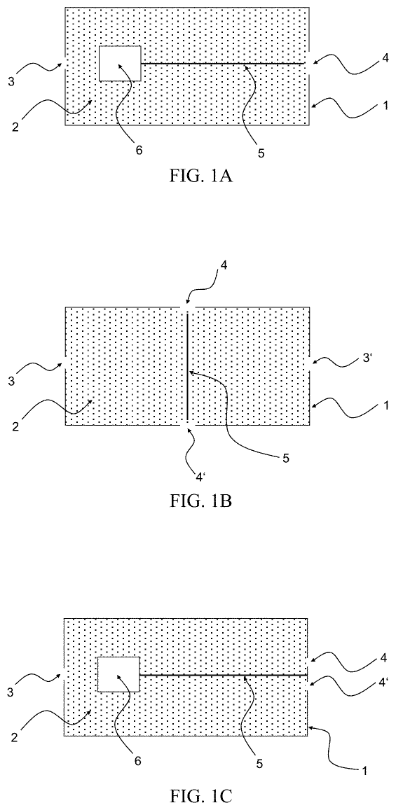

The foam separator can be made from different materials, e.g. metal like aluminum and steel; wood; foam; plastic like polyamide, polyester like polyethylene terephthalate and polybutylene-terephtalate, polystyrene, styrene-acrylonitrile copolymers; and reinforced plastics. The foam separator may be coated by an adhesion promoting agent, which enhances the adhesion between the thermally insulating foam generated and the foam separator e.g. a resin adhesive like epoxy resin. Preferably the foam separator is laminar, i.e. is mainly twodimensional. The foam separator may be flat or curved. The thickness of the laminar foam separator depends on its size, its material and the application and may vary e.g. between be in the range of 0.1 to 5 mm, preferred of 1 to 2 mm. The foam separator may be partial or complete. A “partial foam separator” means herein that the foam separator does not extend over the complete area of convergence, e.g. that it does not have a direct connection to the casing at one side due to an air outlet placed in the casing. Examples for such partial air outlets are shown in FIGS. 1a) and 1b). According to the invention a foam separator covers at least 50% of the area of convergence, preferably at least about 70% and most preferred at least 90% of the area of convergence. The term “complete foam separator” means, that the foam separator covers the whole area of convergence and contacts the casing. An example of such foam separator can be seen in FIG. 1c).

The casing comprises at least one air outlet. This air outlet is usually an opening pervious to air in the casing, e.g. a circular, an angular or a slit like hole. The dimensions of the at least one air outlet depends on the form of the outlet and the application and may e.g. vary from 1 to 5 mm diameter for circular and side lengths of rectangular outlets. Slit like outlets may have a breadth in the range of 0.5 to 5 mm, preferably in the range of 1 to 3 mm and a length which is at least twofold its breadth.

According to one embodiment of the invention at least one air outlet is provided in the casing at the upper end of the foam separator. Usually the air to be replaced has a lower density than the foam reaction mixture and rises easier. The provision of the air outlet above the foam separator enhances a complete filling of the cavity by the foam with less disturbance by the air leaving the cavity. According to another embodiment of the invention at least one air outlet is provided in the casing at the rear end of the foam separator seen in the flow direction of the at least two converging streams. The term “at the rear end of the foam separator seen in the flow direction of the at least two converging streams” means close to the rear end of the foam separator and could be defined in case of a complete foam separator as the actual connection place of the foam separator and the casing in the flow direction of the converging streams. In case of a partial foam separator said term means the imaginary crossing point, where the extended line of the foam separator would meet the casing in the flow direction of the converging streams. It might be necessary for technical reasons to place the air outlet slightly away from the mathematically exact point, such deviated location of the air outlet should be included in the term “at the rear end of the foam separator seen in the flow direction of the at least two converging streams” as long as they are sufficiently close to the mathematically exact point allow the air to vent at the rear end of the foam separator. An example of such deviation is the location of the air outlets (4, 4′) in FIG. 1c). It is also possible that the location of an air outlet is simultaneously at the upper end and at the rear end of the foam separator, see e.g. air outlet (4) in FIG. 1b).

According to the present invention at least two separate streams of the polyurethane reaction mixture converge during the injection and/or the foaming process. With “during the injection and/or the foaming process” it is meant, that during the injection the foam reaction mixture flows into the casing and fills the cavity formed by the casing and optionally present obstacles. At the same time or shortly after the foaming reaction starts and the foam reaction mixture expands which also contributes to the filling of the cavity and with progressing time these two processes superimpose. The convergence of the two streams may occur in each stage of the filling of the cavity.

The at least two converging streams of the polyurethane foam reaction mixture may be generated from a stream of the polyurethane foam reaction mixture by an obstacle located within the casing within the flow direction of the stream of the polyurethane foam reaction mixture, wherein said obstacle divides the stream into at least two separate streams. According to the present invention the term “obstacle” means any article present within the casing and altering the flow of the injected streams of the foam reaction mixture. Such articles may be intended to be placed within thermally insulating foam, e.g. like pipes, heat exchanger, condenser, vacuum insulation panels etc. in a refrigerator wall. An obstacle may also be a continuous opening through the casing, e.g. in case of a side part of a caravan comprising a window, the inner and the outer wall of the caravan side part forms the casing and the hole formed by the window is the obstacle in form of a continuous opening. The casing may contain one, two or more obstacles.

It is also possible that the casing comprises at least one second inlet for the polyurethane foam reaction mixture and at least one of at least two converging streams of the polyurethane foam reaction mixture stems from the polyurethane foam reaction mixture injected into the first inlet and at least one of the at least two converging streams of the polyurethane foam reaction mixture stems from the polyurethane foam reaction mixture injected into the second inlet.

A combination of the two possible origins of at least two separate streams described above is also possible.

Examples of casings already filled with a thermally insulating polyurethane foam are shown schematically in FIG. 1a), b) and c). In FIGS. 1 a) to c) casings (1) are shown filled with a thermally insulating polyurethane foam (2) and having one or two inlets for the injection of the polyurethane foam reaction mixture (3, 3′), one or two air outlets (4, 4′), one foam separator (5) and in case of FIGS. 1a) and c) an obstacle (6) which could be an insert placed within the casing or a continuous opening extending through the casing vertical to the paper plane. FIGS. 1a) and c) show an example of one injected stream which is divided into two separated by an obstacle (6) present in the casing. The two streams converge after passing the obstacle (6). According to the present invention a foam separator (5) is placed along the area of convergence of the two streams and one or two air outlets (4, 4′) are provided in the casing (1) at the rear end of the foam separator (5) seen in the flow direction of the at least two converging streams.

In FIG. 1b) a casing is shown having two inlets (3, 3′) for the injection of the foam reaction mixture located at opposite sides of the casing (1), two air outlets (4, 4′) located at opposite sides of the casing (2) and a foam separator (5) provided along the area of convergence of the two streams injected though the two inlets (3, 3′). The two air outlets (4, 4′) are provided at the rear ends of the foam separator (5) seen in the flow direction of the at least two converging streams, since in this case each injected stream is directed by the foam separator (5) into two directions.

According to one embodiment the air outlet is provided at the rear end of the foam separator and has a slit like form extending parallel to the foam separator in the casing. The breadth of such slit like air outlet is typically in the range of 0.5 to 5 mm, preferably in the range of 1 to 3 mm, the length is usually chosen according to the dimension of the foam separator, e.g. +/−10% or the length of the foam separator facing the casing. It is also possible to provide two or more air outlets along the foam separator in the casing to allow a uniform removal of the air out of the casing, e.g. it is possible to place a series of two or more circular or square holes in the casing along the foam separator or to provide a slit like air outlet in the casing on each side of the foam separator extending parallel to the foam separator where the foam separator is directly connected to the casing , see for example air outlets (4) and (4′) in FIG. 1c).

The air outlet(s) may be completely open during the process of the injecting the foam reaction mixture and the foam generation. The air outlet(s) may also be closed by a cap or closing, which is pervious to air but not to the foam reaction mixture. Such cap or closing may for example be an open celled foam which lets the air moving outside but not the foam reaction mixture or a dense woven network which cannot passed by the viscous foam reaction mixture. The at least one air outlet may be closed after the foam formation process by a dense cap or sealing to avoid the entry of outside compounds from the exterior into the casing or the exchange of compounds between the interior of the casing and the exterior.

The process as described above is particular suited for the production insulating article wherein the thermally insulating article is the housing of a cooling application; the housing a heat storage system; a pipe; a construction board; a side wall of a caravan, panel for roofs from industry halls; the housing of a water boiler, a burner, or a chimney; the cover of an instrument panel; or an engine casing.

The invention likewise relates to the thermally insulating article producible by the process according to the invention.

The invention likewise relates to a thermally insulating article comprising

(i) an in-place-foamed thermally insulating polyurethane foam, and

(ii) a casing surrounding the in-place-foamed thermally insulating foam, said casing comprising
(iia) at least one inlet for the injection of a polyurethane foam reaction mixture for the in-place-foaming the thermally insulating foam,
(iib) at least one air outlet for the air displaced during the in-place-foaming of the thermally insulating foam, and
(iic) at least one foam separator;

wherein the foam separator is located within the in-place-foamed thermally insulating polyurethane foam along the area of convergence of at least two streams of the polyurethane foam reaction mixture during the in-place-foaming of the thermally insulating foam.

The invention likewise relates to a cooling system like a fridge, a heat storage system, an insulation panel for construction, an insulated pipe, or a mobile transport system, a water boiler, a burner, a chimney, an instrument panel, roof of an industry hall, an engine, or a caravan comprising the thermally insulating article as described above.

All above-listed embodiments and preferred embodiments are preferably freely combinable with one another, unless the context explicitly goes against this.

The expressions “comprising” and “comprises” preferably also encompass the expressions “consisting”, “consisting of” or “consists of”.

The invention is illustrated in more detail by the following examples without limiting the invention.

### EXAMPLES

Simulations of the filling process were performed for two different casings by 3D CFD-simulation (Computational-Fluid-Dynamics) over time. OpenFoam (www.openfoam.com) Volume of Fluid (VOF) solver was extended to foaming systems. Separate functions for both density and viscosity over time were required. At the beginning the reacting fluid system was injected with a specified mass flow. During the foaming reaction the air pesent in the casing is displaced and the foaming system extends in the direction of the outlet.

The effect of the presence of a foam separator in a casing which is filled with a foam reaction mixture is shown by means of simulation data. The volume to be foamed was determined based on the geometry of the cavity to be filled. The targeted density at the end of the simulation was predefined. This predefined value determined the required amount of fluid to be injected and together with a typical time of injection of 3 to 8 sec the mass flow rate at the inlet was calculated.

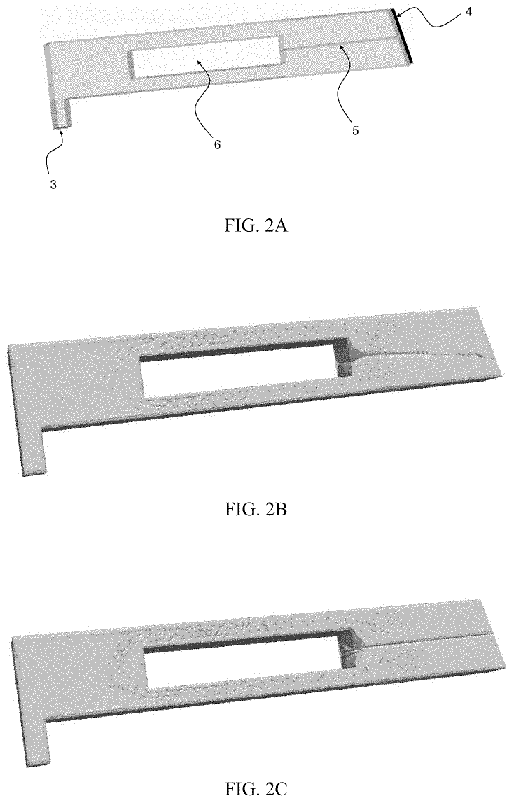

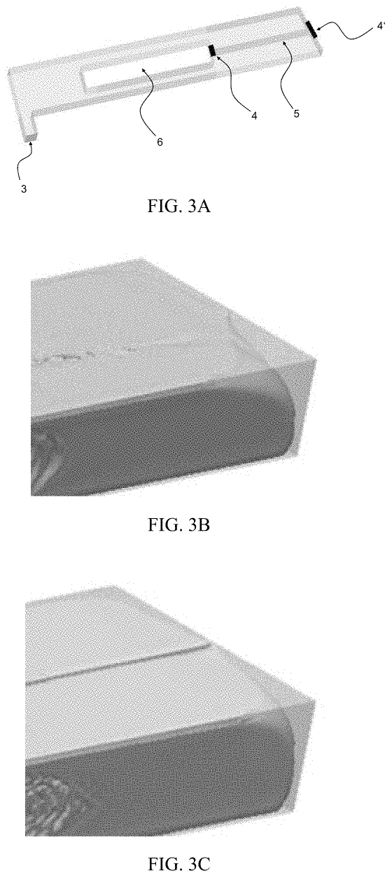

The results of the simulation of the filling of a casing are shown in FIGS. 2 and 3 in three-dimensional schemes. In FIGS. 2a) and 3a) casings are shown with one lateral inlet for injection (3) and an obstacle (6) dividing the stream of foam reaction mixture injected by the lateral inlet (3) into two streams. Both casings are displayed with the foam separator (5). The casings of FIGS. 2a) and 3a) are different in respect of the placement of the air outlet(s). In FIG. 2a) a slit like air outlet (4) is provided at the rear end of the foam separator (5) extending along the whole wall vertical to the foam separator in the upper end of the casing. In FIG. 3a) two small air outlets (4, 4′) are provided at the upper end of the casing and the foam separator (5), one at the right end close to the obstacle and one on the left end at the crossing point of separator and upper wall. In FIGS. 2b) and c) the results for filling the casing of FIG. 2a) without and with a foam separator and in FIGS. 3b) and c) the results for filling the casing of FIG. 3a) without and with a foam separator are displayed. The dark gray areas within the foam denote areas with inhomogeneous density distribution as indication of inhomogeneous flow and bad mixing of the two streams generated by the obstacle. In FIG. 2b) the inclined weld line is visible, whereas in FIG. 2c) the foam separator leads to a straight line in the area of convergence and homogeneous filling of the casing. In FIG. 3b) and c) magnifications of the right corners of the casings are displayed demonstrating that the foam separator leads to a better filling of the edges at the rear end of the casing and inhibits the inclined weld line.

1-18. (canceled)

19. A process for preparing a thermally insulating article, the process comprising:
injecting a polyurethane foam reaction mixture into at least one first inlet of a casing, and
foaming the polyurethane foam reaction mixture;
wherein the thermally insulating article comprises:
a thermally insulating polyurethane foam producible in place by foaming a foam reaction mixture, and
the casing surrounding the thermally insulating polyurethane foam, said casing comprising
the at least one first inlet for the injection of the polyurethane foam reaction mixture,
at least one air outlet for air displaced during the foaming of the polyurethane foam reaction mixture, and
at least one foam separator;
wherein during the injection and/or foaming, at least two streams of the polyurethane foam reaction mixture converge within the casing,
wherein the at least one foam separator is provided along an area of convergence of the at least two streams, and
wherein the area of convergence means an area where the at least two streams of the polyurethane foam reaction mixture would meet and converge in case there would be no foam separator.

20. The process according to claim 19, wherein the at least two streams of the polyurethane foam reaction mixture are generated from a first stream of the polyurethane foam reaction mixture by an obstacle located within the casing, within a flow direction of the first stream of the polyurethane foam reaction mixture, dividing the first stream into the at least two streams.

21. The process according to claim 19, wherein the casing comprises at least one second inlet for the polyurethane foam reaction mixture and wherein at least one of the at least two streams of the polyurethane foam reaction mixture stems from the polyurethane foam reaction mixture injected into the at least one first inlet and at least one of the at least two streams of the polyurethane foam reaction mixture stems from the polyurethane foam reaction mixture injected into the at least one second inlet.

22. The process according to claim 19, wherein the casing includes a continuous opening.

23. The process according to claim 19, wherein the at least one foam separator is laminar.

24. The process according to claim 19. wherein the at least one air outlet is provided in the casing at an upper end of the at least one foam separator.

25. The process according to claim 19, wherein the at least one air outlet is located at a rear end of the at least one foam separator seen in a flow direction of the at least two streams of the polyurethane foam reaction mixture.

26. The process according to claim 25, wherein the at least one air outlet is a slit like opening arranged along the rear end of the at least one foam separator.

27. The process according to claim 19, wherein the at least one air outlet is closed with a material pervious to air.

28. The process according to claim 19, wherein the at least one foam separator is made of at least one material selected from the group consisting of metal; wood; foam; plastic; and reinforced plastic.

29. The process according to claim 19, wherein the at least one foam separator is coated by an adhesion promoting agent.

30. The process according to claim 19, wherein the thermally insulating polyurethane foam is a rigid polyurethane foam.

31. The process according to claim 19, wherein the thermally insulating polyurethane foam is a closed-cell foam.

32. The process according to claim 19, wherein the thermally insulating polyurethane foam has a density of 20 to 300 kg/m³.

33. The process according to claim 19, wherein the thermally insulating article is an article selected from the group consisting of a housing of a cooling application; a housing of a heal storage system; a pipe; a construction board; a side wall of a caravan, a panel for roofs from industry halls; a housing of a water boiler, a burner, or a chimney; a cover of an instrument panel; and an engine casing.

34. The thermally insulating article produced by the process according to claim 19.

35. A thermally insulating article, comprising:
an in-place-foamed thermally insulating polyurethane foam, and
a casing surrounding the in-place-foamed thermally insulating polyurethane foam, said casing comprising
at least one inlet for injection of a polyurethane foam reaction mixture for in-place-foaming the thermally insulating polyurethane foam,
at least one air outlet for air displaced during the in-place-foaming of the thermally insulating polyurethane foam, and
at least one foam separator;
wherein the at least one foam separator is located within the in-place-foamed thermally insulating polyurethane foam along an area of convergence of at least two streams of the polyurethane foam reaction mixture during the in-place-foaming of the thermally insulating polyurethane foam, and
wherein the area of convergence means an area where the at least two streams of the polyurethane foam reaction mixture would meet and converge in case there would be no foam separator.

36. A cooling system, comprising the thermally insulating article according to claim 34,
wherein the cooling system is an article selected from the group consisting of a fridge, a heat storage system, an insulation panel for construction, an insulated pipe, a mobile transport system, a water boiler, a burner, a chimney, an instrument panel, a roof of an industry hall, an engine, and a caravan.

37. The process according to claim 28, wherein the metal is selected from the group consisting of aluminum and steel; and wherein the plastic is selected from the group consisting of a polyamide, a polyester, a polystyrene, and a styrene-acrylonitrile copolymer.

38. A cooling system, comprising the thermally insulating article according to claim 35,
wherein the cooling system is an article selected from the group consisting of a fridge, a heat storage system, an insulation panel for construction, an insulated pipe, a mobile transport system, a water boiler, a burner, a chimney, an instrument panel, a roof of an industry hall, an engine, and a caravan.
